(19) United States
(12) Patent Application Publication
(10) Pub. No.: US 2011/0050392 A1
(43) Pub. Date: Mar. 3, 2011

(54) COMMUNICATION DEVICE

(75) Inventor: Hiroyasu KAIZU, Anpachi-cho (JP)

(73) Assignee: Kyocera Corporation, Kyoto (JP)

(21) Appl. No.: 12/869,638

(22) Filed: Aug. 26, 2010

(30) Foreign Application Priority Data
Aug. 27, 2009 (JP) 2009-196979

(51) Int. Cl. G08B 29/00

(52) U.S. Cl. 340/5.52

(57) ABSTRACT

A method for operating an electronic device is disclosed. First biological information of a first operator performing an input operation to the electronic device is detected. Second biological information from a second operator of a second electronic device is received. Third biological information of a registered person permitted to use the electronic device is provided. A display module is prohibited from displaying received data if the first biological information does not correspond to the second biological information and the first biological information does not correspond to the third biological information.

### CROSS-REFERENCE TO RELATED APPLICATION

The present application claims priority under 35 U.S.C. §119 to Japanese Patent Application No. 2009-196979, filed on Aug. 27, 2009, entitled “COMMUNICATION DEVICE”. The content of which is incorporated by reference herein in its entirety herein.

### FIELD

Embodiments of the present disclosure relate generally to communication devices, and more particularly relate to communication devices operable to detect biological information of a user.

### BACKGROUND

Biometric identification may be used for recognizing persons based upon one or more unique intrinsic physical or behavioral trait. Biometric identification may be used for security to control and manage access to an electronic device. Many electronic devices comprise a touch screen or other sensing device that may be usable for biometric identification.

### SUMMARY

A method for operating an electronic device is disclosed. First biological information of a first operator performing an input operation to the electronic device is detected. Second biological information from a second operator of a second electronic device is received. Third biological information of a registered person permitted to use the electronic device is provided. A display module is prohibited from displaying received data, if the first biological information does not correspond to the second biological information and to the third biological information.

In a first embodiment, a communication device comprises an operation module operable to accept an input operation performed by an operator, and a biological information detection module operable to detect first biological information of the operator. The communication device further comprises a receiver module operable to receive received data comprising second biological information of a transmitter, and a display module operable to display the received data if not prohibited. The communication device also comprises a control module operable to prohibit the display module from displaying the received data, if the first biological information does not correspond to the second biological information and the first biological information does not correspond to third biological information. The third biological information is of a registered person permitted to use the communication device.

In a second embodiment, a method for operating an electronic device comprises detecting first biological information of a first operator performing an input operation to the electronic device. The method further comprises receiving second biological information from a second operator of a second electronic device, and providing third biological information of a registered person permitted to use the electronic device. The method also comprises not displaying received data, if the first biological information does not correspond to the second biological information and the first biological information does not correspond to the third biological information.

In a third embodiment, a computer readable medium comprises program code for operating an electronic device. The program code comprises detecting first biological information of a first operator performing an input operation to the electronic device, and receiving second biological information from a second operator of a second electronic device. The program code further comprises providing third biological information of a registered person permitted to use the electronic device, and prohibiting a display module from displaying the received data if the first biological information does not correspond to the second biological information and the first biological information does not correspond to the third biological information.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the present disclosure. The figures are provided to facilitate understanding of the present disclosure without limiting the breadth, scope, scale, or applicability of the present disclosure. The drawings are not necessarily made to scale.

FIG. 1 is an illustration of a communication environment according to an embodiment of the present disclosure.

FIG. 2 is an illustration of a schematic functional block diagram of mobile terminal system according to an embodiment of the disclosure.

FIG. 3 is an illustration of a flowchart showing a transmission process of a mobile terminal according to an embodiment of the disclosure.

FIG. 4 is an illustration of a table of a communication partner terminal and an authorization level stored in a storage device according to an embodiment of the disclosure.

FIG. 5 is an illustration of a flowchart showing a receiving process of a mobile terminal according to an embodiment of the disclosure.

FIG. 6A-C are illustrations of flowcharts showing receiving processes of a mobile terminal according to embodiments of the disclosure.

FIG. 7 is an illustration of a table showing contents of an address book of a mobile terminal according to an embodiment of the disclosure.

FIGS. 8A and 8B are illustrations of flowcharts showing receiving processes of a mobile terminal according to embodiments of the disclosure.

FIG. 9 is an illustration of a flowchart showing a receiving process of the mobile terminal according to an embodiment of the present disclosure.

FIG. 10 is an illustration of a table showing contents of the address book stored in the storage device according to an embodiment of the disclosure.

FIG. 11 is an illustration of a flowchart showing a receiving process of a mobile terminal according to an embodiment of the disclosure.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. Furthermore, there is no intention to be bound by any expressed or implied theory presented in the preceding field, background, summary or the following detailed description. The present disclosure should be accorded scope consistent with the claims, and not limited to the examples described and shown herein.

Embodiments of the disclosure are described herein in the context of one practical non-limiting application, namely, a cell phone. Embodiments of the disclosure, however, are not limited to such cell phones, and the techniques described herein may also be utilized in other applications. For example, embodiments may be applicable to mobile phones, digital books, digital cameras, electronic game machines, digital music players, personal digital assistance (PDA), personal handy phone system (PHS), lap top computers, and the like.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

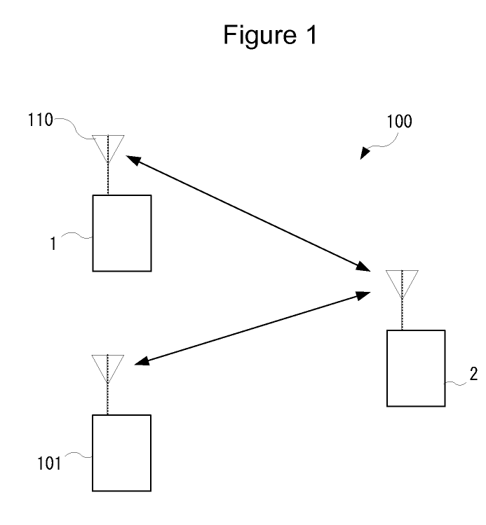

FIG. 1 is an illustration of a communication environment 100 according to an embodiment of the disclosure. The communication environment 100 may comprise two or more mobile terminals 1/101 and at least one base station 2. The mobile terminal 1 and the mobile terminal 101 perform communication wirelessly therebetween via the base station 2 through antenna 110. The mobile terminal 1 and the mobile terminal 101 may each comprise, for example but without limitation, a cell phone, a PDA, and the like. Hereinafter, the mobile terminal 1 and the mobile terminal 101 are described as cell phones.

The antenna 110 may be, for example but without limitation, a built-in antenna, a rod antenna, and the like. The antenna 110 is configured to transmit and receive electromagnetic waves at a predetermined frequency band to and from the base station 2. The antenna 110 may comprise a single antenna or multiple antennas.

The mobile terminal 1 transmits transmission data to which fingerprint data of an operator operating the mobile terminal 1 is added to the mobile terminal 101 of a communication partner. As used herein data to which fingerprint data is added may comprise data obtained by integrating fingerprint data with data other than the fingerprint data, or data other than fingerprint data to which fingerprint data is added. Data to which fingerprint data is added is the former; that is, the transmission data of the mobile terminal 1 comprises, the fingerprint data, sound data, contents of e-mails, an e-mail address identifying the mobile terminal 1, fingerprint data of an operator operating the mobile terminal 1, and the like. Hereinafter, a person who operates the mobile terminal 1 and transmits the transmission data from the mobile terminal 1 to the mobile terminal 101 is referred to as a “transmitter”. The mobile terminal 101 with which the mobile terminal 1 communicates may be referred to as a “communication partner terminal 101”.

The mobile terminal 1 receives fingerprint-added data, comprising the transmitter's fingerprint data, form the communication partner terminal 101. The mobile terminal 1 also receives non-fingerprint-added data from the communication partner terminal 101 to which the transmitter's fingerprint data is not added.

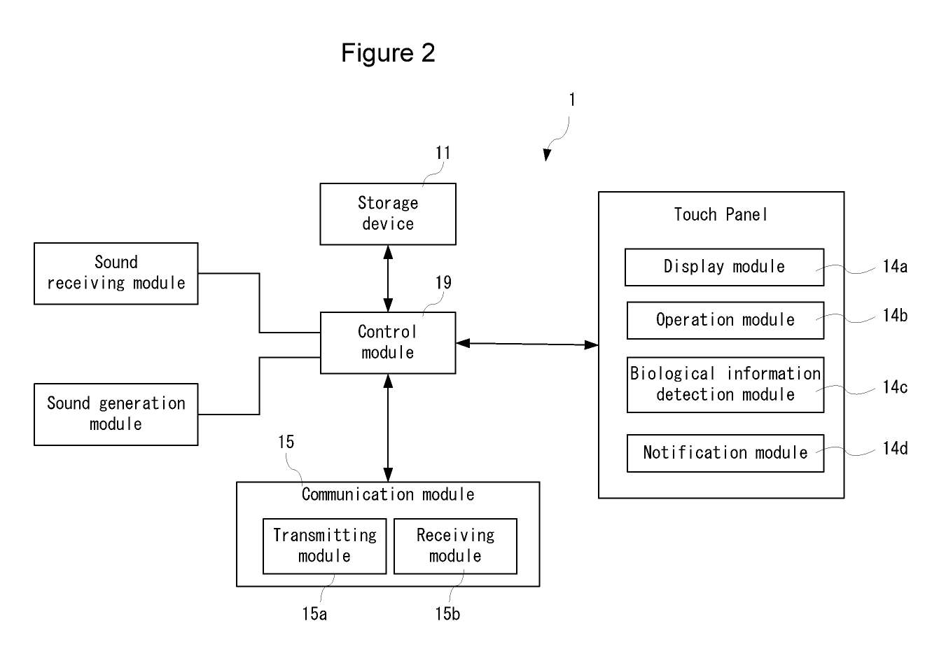

FIG. 2 is an illustration of a schematic functional block diagram of a mobile terminal 1 according to an embodiment of the disclosure. The mobile terminal 1 comprises a storage device 11, a sound receiving module 12, a sound generation module 13, a touch panel 14, a communication module 15, and a control module 19.

The storage device 11 is operable to store various kinds of data used for various processes of the mobile phone 1. In an embodiment, the storage device 11 may comprise a cache memory for storing temporary variables or other intermediate information during execution of instructions to be executed by the control module 19. In practical embodiments, the storage device 11 may comprise, for example but without limitation, a non-volatile storage device (non-volatile semiconductor memory, hard disk device, optical disk device, and the like), a random access storage device (for example, SRAM, DRAM), or any other form of storage medium known in the art. The storage device 11 may store a plurality of application programs such as: a call program, an email program, address book, authorization level, fingerprint-added data, non-fingerprint-added data, a temporary data used in a program process, reference fingerprint data used in performing the fingerprint authentication, personal information, a computer program which is executed by the storage device 11, an operating system (OS), tentative data used in executing a program processing, and the like.

The storage device 11 may be coupled to the control module 19 such that the storage device 11 can read information from and write information to the control module 19. As an example, the control module 19 and storage device 11 may reside in their respective ASICs. The storage device 11 may also be integrated into the control module 19. In an embodiment, the storage device 11 may comprise a cache memory for storing temporary variables or other intermediate information during execution of instructions to be executed by the control module 19. The storage device 11 may also comprise non-volatile memory for storing instructions to be executed by the control module 19.

The storage device 11 stores registration information of the users registered in the mobile terminal 1. Moreover, the storage device 11 a priori stores fingerprint data of the registered users of the mobile terminal 1. Hereinafter, a person whose fingerprint data have been registered (stored) in the storage device 11 and who is permitted to use the mobile terminal 1 is referred to as a “registered person” and the fingerprint data is referred to as “registered person's fingerprint data.

The sound receiving module 12 may comprise a microphone (not shown) and output an encoded digital voice for input to the control module 19, by converting an analog voice input received by the microphone from outside. In this manner, the sound receiving module 12 may amplify the analog voice input from the microphone, and carry out an analog/digital conversion to obtain a digital voice input. The sound receiving module 12 may apply a signal processing such as an encoding, or the like, to the digital voice input to obtain an encoded digital voice input, and send the encoded digital voice input to the control module 19.

The sound generation module 13 may comprise a speaker (not shown) and output a digital voice data supplied from the control module 19. The sound generation module 13 may apply a signal processing to the digital voice data supplied from the control module 19. In this manner, the sound generation module 13 performs decoding, digital/analog conversion, and amplification to convert the digital voice data to an analog voice signal for output to the speaker.

The touch panel 14 comprises: a display module 14a configured to display various information; an operation module 14b configured to accept input operations; and a biological information detection module 14c configured to detect fingerprint data of the operator performing input operations on the operation module 14b (hereinafter referred to as “operator's fingerprint data”).

Various kinds of information such as an icon for starting an application program or text can be displayed on the display module 14a of the touch panel 14 via an image/video signal supplied from the control module 19. Furthermore, the touch panel 14 detects the operations of a finger of an operator thereupon and outputs the operations of the finger of the operator to the control module 19. Moreover, the biological information detection module 14c of the touch panel 14 detects the fingerprint of the operator's finger that has touched the touch panel 14 as explained in more detail below. The touch panel 14 may comprise a scanner function using a photodetector element, or a capacitance-type touch panel.

In one embodiment, the touch panel 14 may comprises hardware different from a touch panel configuration. Alternatively, the mobile terminal 1 may comprise a display module 14a, an operation module 14b, and a biological information detection module 14c each comprising a separate hardware.

The display module 14a may be formed by, for example but without limitation, a liquid crystal (LCD) panel, an organic electro-luminescence (OEL) panel, and the like. The display module 14a displays various items of information on the LCD. The display screen on the LCD (an operation input screen on the touch panel 14) is provided with a plurality of optical sensors (not shown) arranged in a grid pattern. Each of the optical sensors detects an amount of light coming in from the front side of the touch panel 14. When the operator's finger touches the display screen of the LCD while a backlight of the LCD emits light, the light from the backlight of the LCD is reflected by the operator's finger. The optical sensor with which the operator's finger is in contact detects light inputted from the front side and reflected by the operator's finger. As a result, the amount of light detected by the optical sensor with which the operator's finger is in contact is different from the amount of light detected by the optical sensors with which the operator's finger is not in contact. Therefore, the operation module 14b can accept the operator's input operations to the touch panel 14 based on the amount of light detected by each of the plurality of optical sensors. Of the concave portions and convex portions on a surface of the operator's finger that form fingerprints, the light from the backlight of the LCD is reflected on the concave portions. Therefore, the amount of light reflected from the operator's finger is different between the concave portions and convex portions on the surface of operator's finger. Therefore, the biological information detection module 14c detects the operator's fingerprint data based on amount of light detected by each of the plurality of optical sensors.

The control module 19 is notified of input operations performed by the operator and accepted by the operation module 14b, along with the operator's fingerprint data detected by the touch panel 14. Input operations may comprise a request for displaying the fingerprint-added data received by the communication module 15. When the control module 19 is notified that the input operations have been performed on the touch panel 14, the control module 19 determines whether the operator's fingerprint data detected by the biological information detection module 14c correspond to the registered person's fingerprint data. In this manner, the control module 19 performs fingerprint authentication to determine whether the operator of the mobile terminal 1 is a registered person. The control module 19 displays the fingerprint-added data on the display module 14a, if the operator's fingerprint data is authenticated. The authentication allows the operator of the mobile terminal 1 to browse the fingerprint-added data on the mobile terminal 1 if he/she is a registered person of the mobile terminal 1.

As described below, the control module 19 determines whether a “transmitter” who transmitted the fingerprint-added data using another mobile terminal to the mobile terminal 1 comprising the control module 19 is the owner of the other mobile terminal (hereinafter referred to as “transmitting terminal owner”), or whether he/she is impersonating the transmitting terminal owner. The notification module 14d of the touch panel 14 notifies the user of the mobile terminal 1 of a result of the determination of impersonation. For example, the notification module 14d sends an external notification that the transmitter is impersonating the transmitting terminal owner, by displaying a text message on the display module 14a. The user may also be notified of the result of the determination of the impersonation by, for example but without limitation, a sound, a light, and the like. In this manner, the control module 19 may send the result of the determination of the impersonation to the sound generation module 13 for outputting a sound or to a light-emitting module such as an LED to output a light.

The communication module 15 is operable to transmit and receive a plurality of communication signals comprising data signals via the base station 2. For example, the transmitting module 15a modulates a transmitting signal such as fingerprint-added data, or non-fingerprint-added signal as a radio signal to the communication partner terminal 101 through the antenna 110. In addition, the receiver module 15b demodulates a radio signal such as a fingerprint-added data received from the communication partner terminal 101 through the antenna 110, and sends the fingerprint-added data to the control module 19. The communication module 15 communicates with the wireless network via a wireless data communication link (not shown). The communication module 15 cooperates with the base station transceiver (not shown) with a suitably configured RF antenna arrangement such as the antenna 110 that can support a particular wireless communication protocol and modulation scheme to transmit and receive data signals. The data signals (transmission data) may comprise, for example but without limitation, fingerprint data, voice data during voice communication, text data during email, web data during accessing web site, and the like.

The control module 19 may comprise transmission/reception of signals at the communication module 15. The control module 19 controls overall operation of the mobile terminal 1. For example, the control module 19 may control operations of the mobile phone 1 so that processes of the mobile phone 1 are suitably performed such that various processing are performed by proper procedures. These processes comprise, for example but without limitation, call-processing, email-processing, browser-processing, navigation-processing, audio-processing, touch panel control, fingerprint data processing in performing the fingerprint authentication, personal information acquiring, determining operational content, and the like. The control module 19 also controls a communication of the communication module 15, and access to the storage device 11 such as access to the fingerprint data, and the like. For example, the control module 19 can control the communication module 15 to process a telephone call or an electronic mail. For another example, the control module 19 can control the touch panel 14 to detect an action or an operation of a finger of a user/operator, and display various kinds of information such as a notification on the notification module 4d.

The control module 19 may comprise a computer CPU (microprocessor) or another processor for performing a process based on a program (operating system, application program, etc.) stored in the storage device 11. The control module 19 may read instruction code sequentially from programs such as the operating system and the application program, which are stored in the storage device 11, and perform the programs. For example, a fingerprint authentication process in the control module 19 may be realized on the computer by one or a plurality of programs, or may be at least partially realized by hardware.

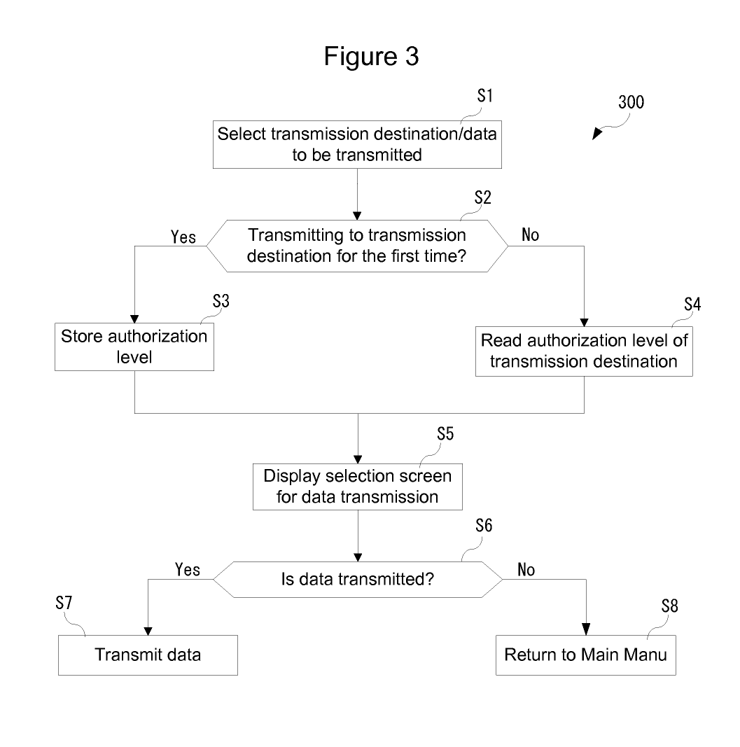

FIG. 3 is an illustration of a flowchart showing a transmission process 300 of the mobile terminal 1. Process 300 may begin by, the operator of the mobile terminal 1 operating the touch panel 14 to select the communication partner terminal 101 as the transmission destination and the data to be transmitted to the communication partner terminal 101 (task S1).

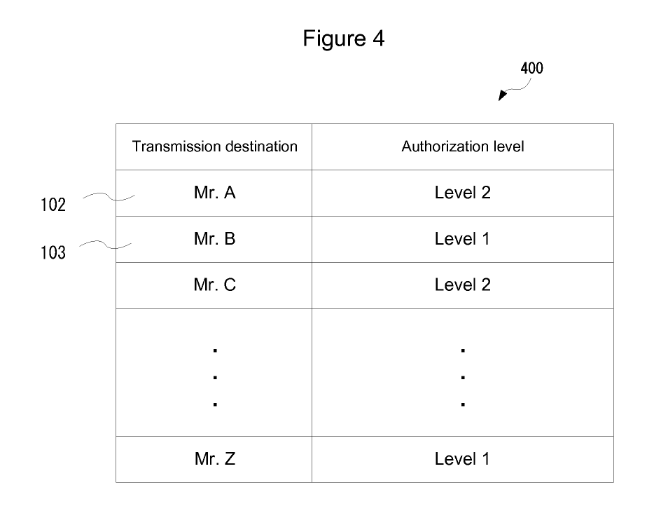

Next, the control module 19 determines whether the mobile terminal 1 is transmitting the data to the selected communication partner terminal 101 for the first time (inquiry task S2). If the control module 19 determines that the data are being transmitted to the selected communication partner terminal 101 for the first time (“YES” branch of the inquiry task S2), the control module 19 stores an authorization level (FIG. 4) (task S3). However, if the control module 19 determines that the data is not being transmitted to the selected communication partner terminal 101 for the first time (“NO” branch of the inquiry task S2), or in other words, the data have already been transmitted to the communication partner terminal 101, the control module 19 reads authorization level of the transmission destination (task S4).

In task S3, the control module 19 accepts input operations at the authorization level for the selected communication partner terminal 101 on the touch panel 14. The authorization level identifies access authority given to the communication partner terminal 101 for the data to be transmitted. Afterward, when the control module 19 determines that the authorization level has been accepted on the touch panel 14, the control module 19 stores the authorization level in the storage device 11 as the authorization level of the communication partner terminal 101 selected in task S1.

The control module 19 then reads the authorization level for the selected communication partner terminal 101 from the storage device 11. This eliminates the need for the operator to select the authorization level for the touch panel 14 if the data have already been transmitted to the selected communication partner terminal 101. The authorization level stored in the storage device 11 may be changed by the input operation of the operator.

The control module 19 then displays selection screen for data transmission (task S5). The selection screen then prompts whether to “transmit data” (inquiry task S6). If data to be transmitted (“YES” branch of the inquiry task S6) a “YES” button (popup) is activated on the touch panel 14. Otherwise (“No” branch of the inquiry task S6) a “NO” button as a popup is activated, on the touch panel 14.

In this manner, the control module 19 determines whether an input operation has been performed for the “YES” button or the “NO” button on the touch panel 14.

If the control module 19 determines that the input operation has been performed for the “YES” button, the control module 19 transmits the data (task S7). In this manner, the control module 19 detects the operator's fingerprint data on the touch panel 14. The control module 19 adds the operator's fingerprint data to the transmission data to generate the fingerprint-added data and transmits the fingerprint-added data from the transmitting module 15a to the communication partner terminal 101. The transmission data transmitted from the transmitting module 15a of the mobile terminal 1 comprises the authorization level of the communication partner terminal 101.

However, if the control module 19 determines that the input operation has been performed for the “NO” button, it displays the main menu image on the touch panel 14 in (task S8).

FIG. 4 is an illustration of a table of the communication partner terminal 101 and the authorization level stored in the storage device 11. The authorization level is provided with at least two levels in this example: Level 1 and Level 2. If the authorization level of the communication partner terminal 101 is Level 1, authorization to read the data to be transmitted is given to the communication partner terminal 101. If the authorization level of the communication partner terminal 101 is Level 2, authorization to read and write the data to be transmitted is given to the communication partner terminal 101. For example, the mobile terminal 102 of Mr. A is given authorization Level 2 to read and write the data to be transmitted and the mobile terminal 103 of Ms. B is given authorization Level 1 to read the data to be transmitted.

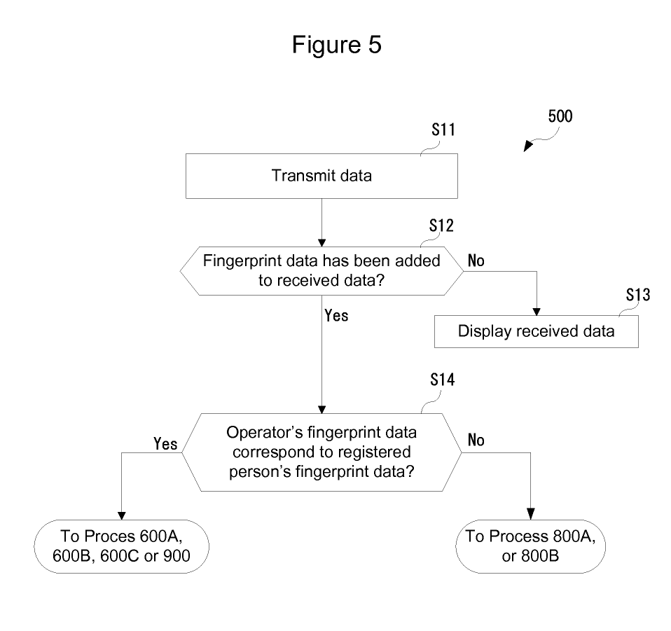

FIG. 5 is an illustration of a flowchart showing a receiving process 500 of the mobile terminal 1. The various tasks performed in connection with the process 500 may be performed by software, hardware, firmware, a computer-readable medium having computer executable instructions for performing the process method, or any combination thereof. The process 500 may be recorded in a computer-readable medium such as a semiconductor memory, a magnetic disk, an optical disk, and the like, and can be accessed and executed, for example, by a computer CPU such as the control module 19 in which the computer-readable medium is stored. It should be appreciated that process 500 may include any number of additional or alternative tasks, the tasks shown in FIG. 5 need not be performed in the illustrated order, and process 500 may be incorporated into a more comprehensive procedure or process having additional functionality not described in detail herein. For illustrative purposes, the following description of process 500 may refer to elements mentioned above in connection with FIGS. 1-4. In practical embodiments, portions of process 500 may be performed by different elements of the mobile terminal 1 for example the storage device 11, the sound receiving module 12, the sound generation module 13, the touch panel 14, the communication module 15, and the control module 19, etc. The process 500 may have functions, material, and structures that are similar to the embodiments shown in FIGS. 1-4. Therefore common features, functions, and elements may not be redundantly described here.

Process 500 may begin by the receiving module 15b receiving data from the communication partner terminal 101 (task S11).

Next, the control module 19 determines whether the received data received at the receiving module 15b are fingerprint-added data or non-fingerprint-added data, or in other words, whether the transmitter's fingerprint data are added to the received data received at the receiving module 15b (inquiry task S12). If the control module 19 determines that the received data received at the receiving module 15b is non-fingerprint-added data (“NO” branch of inquiry task S12), the control module 19 accepts input operations on the touch panel 14 to display the non-fingerprint-added data. Then, when the control module 19 determines that an input operation to display the non-fingerprint-added data has been performed on the touch panel 14, the control module 19 displays the non-fingerprint-added data on the touch panel 14 in task S13.

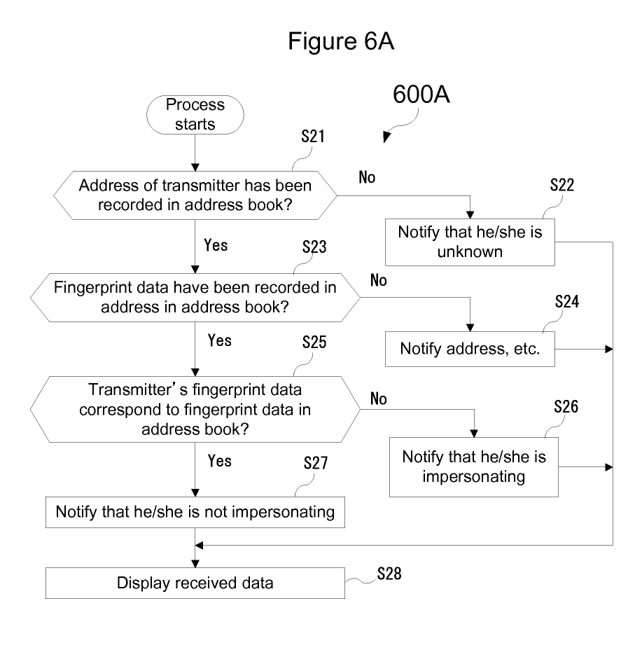

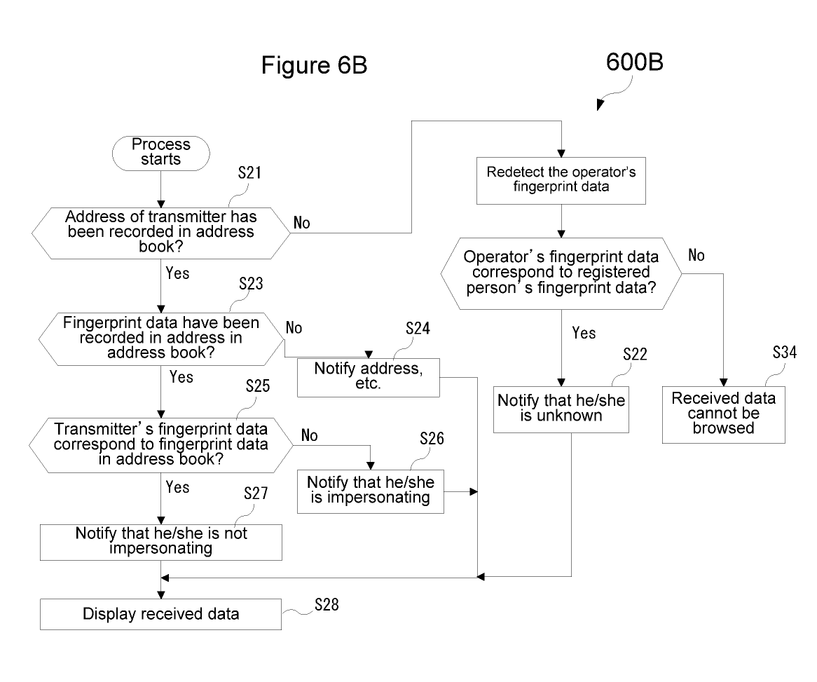

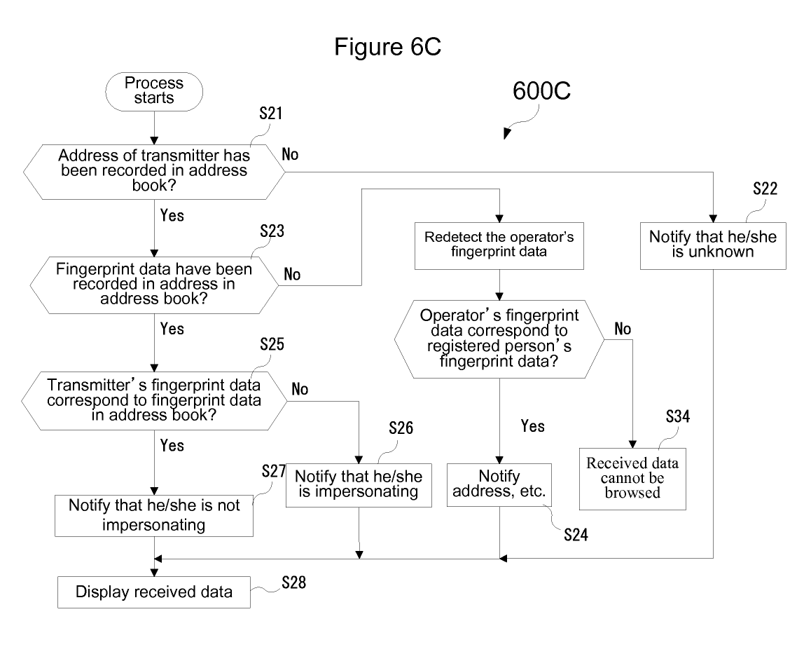

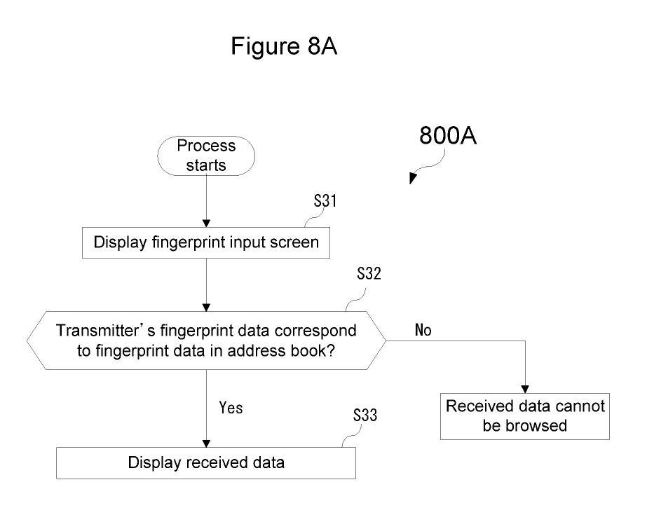

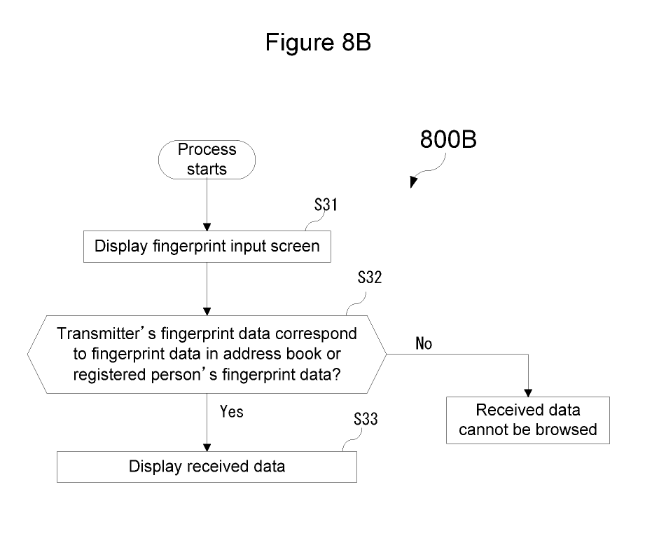

If the control module 19 determines that the received data received at the receiving module 15b are fingerprint-added data (“YES” branch of inquiry task S12), and if the control module 19 accepts the input operation to display the received data on the touch panel 14, the control module 19 detects the operator's fingerprint data on the touch panel 14. Then, the control module 19 determines whether the operator's fingerprint data correspond to the registered person's fingerprint data (inquiry task S14). If the control module 19 determines that the operator's fingerprint data correspond to the registered person's fingerprint data (“YES” branch of inquiry task S14), process 500 performs “process 600A,” “process 600B” or “process 6000” as described in the context of discussion FIG. 6A, 6B or 6C below, respectively and, if the control module 19 determines that the operator's fingerprint data do not correspond to the registered person's fingerprint data (“NO” branch of inquiry task S14), process 500 performs “process 800A” or “process 800B” as described in the context of discussion of FIG. 8A or 8B below, respectively.

FIGS. 6 A to 6C are illustrations of flowchart showing a receiving processes 600A-C of the mobile terminal 1. The various tasks performed in connection with the processes 600A-C may be performed by software, hardware, firmware, a computer-readable medium having computer executable instructions for performing the process method, or any combination thereof. The processes 600A-C may be recorded in a computer-readable medium such as a semiconductor memory, a magnetic disk, an optical disk, and the like, and can be accessed and executed, for example, by a CPU such as the control module 19 in which the computer-readable medium is stored. It should be appreciated that processes 600A-C may include any number of additional or alternative tasks, the tasks shown in FIGS. 6A-C need not be performed in the illustrated order, and processes 600A-C may be incorporated into a more comprehensive procedure or process having additional functionality not described in detail herein. For illustrative purposes, the following description of processes 600A-C may refer to elements mentioned above in connection with FIGS. 1-5. In practical embodiments, portions of process 900 may be performed by different elements of the mobile terminal 1 for example the storage device 11, the sound receiving module 12, the sound generation module 13, the touch panel 14, the communication module 15, and the control module 19, etc. The processes 600A-C may have functions, material, and structures that are similar to the embodiments shown in FIGS. 1-5. Therefore common features, functions, and elements may not be redundantly described here.

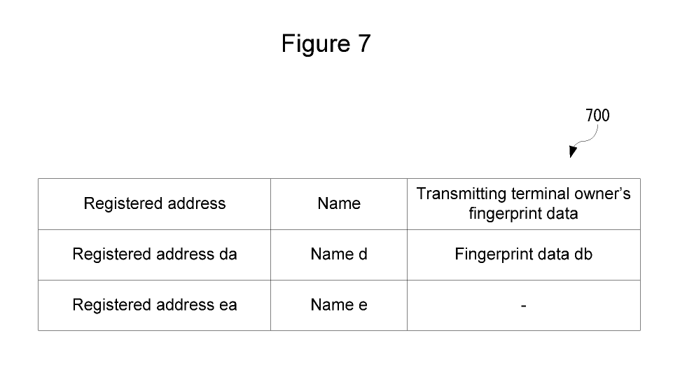

In the processes 600A-C, a registered person owns the mobile terminal 1. Therefore, the registered person can display the fingerprint-added data on the mobile terminal 1. Processes 600 A-C are described with reference to the table 700 shown in FIG. 7.

The control module 19 accesses the address book (FIG. 7) stored in the storage device 11 and determines whether the transmitter is impersonating the transmitting terminal owner.

Process 600A may begin by the control module 19 determining whether the e-mail address included in the fingerprint-added data (hereinafter referred to as “received address”) corresponds to the registered addresses (inquiry task S21). If the control module 19 determines that the received address does not correspond to any of the registered addresses (“NO” branch of inquiry task S21), the control module 19 provides a notification on the notification module 4d of the touch panel 14 that the transmitter is unknown on the touch panel 14 (task S22). For example, if the received address is different from each of the registered addresses da and ea shown in FIG. 7, task S22 is performed. Process 600 may then lead to (task S28) to display the received data.

If the control module 19 determines that the received address corresponds to a registered address (“YES” branch of injury task S21), the control module 19 determines whether the transmitting terminal owner's fingerprint data is stored in the address book in relation to the registered address determined to correspond to the received address in (inquiry task S23).

If the control module 19 determines that the transmitting terminal owner's fingerprint data has not been stored in the address book in relation to the registered address determined to correspond to the received address (“NO” branch of inquiry task S23), the control module 19 provides notification of the registered address on the notification module 14d of the touch panel 14 (task S24). Concurrently, because the control module 19 does not make a determination regarding impersonation, the control module 19 also provides notification that there is a possibility of impersonation. If the name of the transmitting terminal owner is stored in the address book in relation to the registered address determined to correspond to the received address, the control module 19 also provides notification of the name on the notification module 14d of the touch panel 14. For example, if the received address corresponds to the registered address shown in FIG. 7, the touch panel 14 provides notification of the registered address and the name as well as notification that there is a possibility of impersonation because the transmitting terminal owner's fingerprint data have not been stored in the address book in relation to the registered address. Process 600 may then lead to task S28 to display the received data. If the control module 19 determines that the transmitting terminal owner's fingerprint data have been stored in the address book (“YES” branch of inquiry task S23), in relation to the registered address determined to correspond to the received address, the control module 19 determines whether the transmitter's fingerprint data correspond to the transmitting terminal owner's fingerprint data in (inquiry task S25). In this manner, the control module 19 determines whether the transmitter's fingerprint data added to the fingerprint-added data from the communication partner terminal 101 correspond to the fingerprint data of the owner of the communication partner terminal 101. For example, if the registered address da shown in FIG. 7 corresponds to the received address, inquiry task S23 is performed, and because the fingerprint data db have been stored as the transmitting terminal owner's fingerprint data in the address book in relation to this registered address da, inquiry task S25 is performed.

If the control module 19 determines that the transmitter's fingerprint data do not correspond to the transmitting terminal owner's fingerprint data, or in other words, that the transmitter's fingerprint data are different from the transmitting terminal owner's fingerprint data (“NO” branch of inquiry task S25), the notification provided by the notification portion 14d of the touch panel 14 notifies that there is an impersonation in (task S26). For example, if the transmitter's fingerprint data do not correspond to the fingerprint data in FIG. 7, task S26 is performed. Process 600A may then lead to, task S28.

If the control module 19 determines that the transmitter's fingerprint data correspond to the transmitting terminal owner's fingerprint data (“YES” branch of inquiry task S25), the control module 19 provides notification on the notification module 14d of the touch panel 14 that there is no impersonation in (task S27). For example, if the transmitter's fingerprint data correspond to the fingerprint data db in FIG. 7, task S27 is performed. Process 600A, may then lead to, task S28. The control module 19 displays the fingerprint-added data on the touch panel 14 (task S28). The control module 19 then hides the fingerprint-added data that have been displayed on the touch panel 14 if an input operation to hide the fingerprint-added data has been performed on the touch panel 14.

FIG. 7 is an illustration of a table 700 showing contents of an address book stored in the storage device 11. In the address book, e-mail addresses identifying the communication partner terminal 101 (hereinafter referred to as “registered addresses”), names of the transmitting terminal owners, and the fingerprint data of the transmitting terminal owners (hereinafter referred to as “transmitting terminal owner's fingerprint data”) are stored.

FIGS. 8A and 8B are illustrations of flowcharts showing receiving processes 800A-B of the mobile terminal, respectively. The various tasks performed in connection with the processes 800A-B may be performed by software, hardware, firmware, a computer-readable medium having computer executable instructions for performing the process method, or any combination thereof. The processes 800A-B may be recorded in a computer-readable medium such as a semiconductor memory, a magnetic disk, an optical disk, and the like, and can be accessed and executed, for example, by a CPU such as the control module 19 in which the computer-readable medium is stored. It should be appreciated that processes 800A-B may include any number of additional or alternative tasks, the tasks shown in FIG. 8A or 8B need not be performed in the illustrated order, and processes 800A-B may be incorporated into a more comprehensive procedure or process having additional functionality not described in detail herein. For illustrative purposes, the following description of processes 800A-B may refer to elements mentioned above in connection with FIGS. 1-7. In practical embodiments, portions of processes 800A-B may be performed by different elements of the mobile terminal 1 for example the storage device 11, the sound receiving module 12, the sound generation module 13, the touch panel 14, the communication module 15, and the control module 19, etc. The processes 800A-B may have functions, material, and structures that are similar to the embodiments shown in FIGS. 1-7. Therefore common features, functions, and elements may not be redundantly described here.

Process 800A may begin by the control module 19 displaying an indication on the touch panel 14 to prompt the operator to touch the touch panel 14 with his/her finger in (task S31). The control module 19 then redetects the operator's fingerprint data on the biological information detection module 14c of the touch panel 14 and determines whether the operator's fingerprint data correspond to the transmitter's fingerprint data (inquiry task S32). In this manner, the control module 19 determines whether the fingerprint data of the operator redetected by the touch panel 14 correspond to the transmitter's fingerprint data added to the fingerprint-added data from the communication partner terminal 101.

If the control module 19 determines that the operator's fingerprint data redetected by the touch panel 14 correspond to the transmitter's fingerprint data (“YES” branch of inquiry task S32) the control module 19 displays the fingerprint-added data to which the transmitter's fingerprint data have been added on the display module 14a of the touch panel 14 (task S33). Therefore, when the transmitter who transmitted the fingerprint-added data operates the mobile terminal 1 of the transmission destination, the fingerprint-added data are displayed on the mobile terminal 1.

If the control module 19 determines that the operator's fingerprint data redetected by the touch panel 14 do not correspond to the transmitter's fingerprint data (“NO” branch of inquiry task S32), the received data cannot be browsed (task S34). In this manner, control module 19 prohibits the fingerprint-added data from being displayed on the touch panel 14 (task S34) even though an operation to display the fingerprint-added data on the touch panel 14 has been performed on the touch panel 14.

In this manner, if the detected operator's fingerprint data correspond to neither the registered person's fingerprint data nor the transmitter's fingerprint data added to the received fingerprint-added data, the fingerprint-added data are prohibited from being displayed on the touch panel 14. Therefore, even if a third party other than the registered person or transmitter operates the mobile terminal 1, the fingerprint-added data are not displayed on the mobile terminal 1. As a result, it is possible to prevent a third party other than the registered person or transmitter from browsing the fingerprint-added data on the mobile terminal 1. On such a mobile terminal 1, if a third party can obtain approval from the transmitter when the registered person is not nearby but the transmitter is nearby, (i.e., if he/she can ask the transmitter to operate the touch panel 14 in task 31), he/she can browse the data transmitted by the transmitter on the mobile terminal 1.

The mobile terminal 1 operates the communication partner terminal 101 when the registered person browses the fingerprint-added data to determine whether the transmitter who has transmitted the fingerprint-added data is impersonating the owner of the communication partner terminal 101 and provides notification of the result of the determination. Therefore, the registered person can tell whether the transmitter is impersonating the registered owner.

According to an embodiment of the disclosure, the control module 19 again performs fingerprint identification regarding whether the operator of the mobile terminal 1 is a registered person in process 600B-C as shown in FIG. 6B-C, respectively. For example, this re-identification process is performed in at least one of either between task S21 and task S22 as shown in FIG. 6B or between task S23 and task S24 as shown in FIG. 6C. In the re-identification process, the control module 19 redetects the operator's fingerprint data on the touch panel 14 and determines whether the operator's fingerprint data redetected by the touch panel 14 correspond to the registered person's fingerprint data.

If the re-identification process is performed between task S21 and task S22 as shown FIG. 6B, when the control module 19 determines that the operator's fingerprint data redetected by the touch panel 14 correspond to the registered person's fingerprint data, task S22 is performed. If the control module 19 determines that the operator's fingerprint data redetected by the touch panel 14 do not correspond to the registered person's fingerprint data, task S34 is performed.

If the re-identification process is performed between task S23 and task S24 as shown FIG. 6C, when the control module 19 determines that the operator's fingerprint data redetected by the touch panel 14 correspond to the registered person's fingerprint data, task S24 is performed. Otherwise, if the control module 19 determines that the operator's fingerprint data redetected by the touch panel 14 do not correspond to the registered person's fingerprint data, task S34 is performed.

According to an embodiment of the disclosure, from the starting point of processes 600A-C shown in FIG. 6A-C until the point when the touch panel 14 displays the fingerprint-added data in task S28, even if a registered person leaves the mobile terminal 1 behind and a third party obtains the mobile terminal 1, it is possible to prevent the third party from browsing the fingerprint-added data on the mobile terminal 1.

The control module 19 performs the re-identification process by the time when task S28 is performed after each processes 600A-C starts, and for example, it may perform the re-identification process in at least one of either between task S25 and task S26 or between task S25 and task S27.

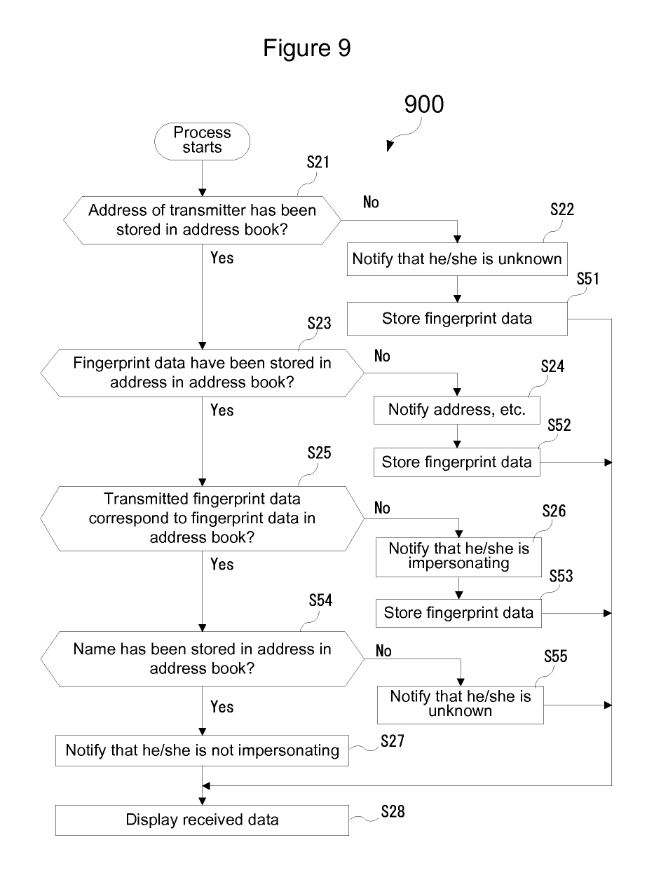

FIG. 9 is an illustration of a flowchart showing a receiving process 900 according to an embodiment of the disclosure. The various tasks performed in connection with the process 900 may be performed by software, hardware, firmware, a computer-readable medium having computer executable instructions for performing the process method, or any combination thereof. The process 900 may be recorded in a computer-readable medium such as a semiconductor memory, a magnetic disk, an optical disk, and the like, and can be accessed and executed, for example, by a CPU such as the control module 19 in which the computer-readable medium is stored. It should be appreciated that process 900 may include any number of additional or alternative tasks, the tasks shown in FIG. 9 need not be performed in the illustrated order, and process 900 may be incorporated into a more comprehensive procedure or process having additional functionality not described in detail herein. For illustrative purposes, the following description of process 900 may refer to elements mentioned above in connection with FIGS. 1-8. In practical embodiments, portions of process 900 may be performed by different elements of the mobile terminal 1 for example the storage device 11, the sound receiving module 12, the sound generation module 13, the touch panel 14, the communication module 15, and the control module 19, etc. The process 900 may have functions, material, and structures that are similar to the embodiments shown in FIGS. 1-8. Therefore common features, functions, and elements may not be redundantly described here.

In the embodiment shown in FIG. 9 process 900 performs tasks S51-S55 in addition to tasks performed in the process 600. Therefore, common features, functions, and elements of process 1600 may not be redundantly described herein.

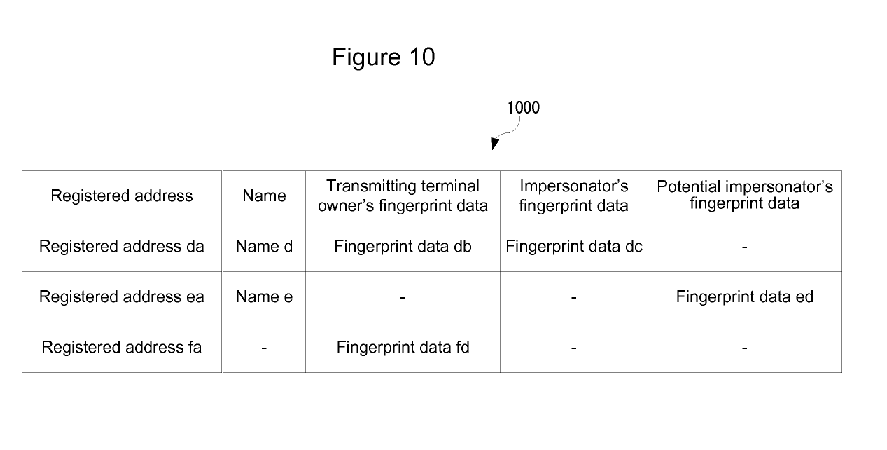

After task S22, the control module 19 stores an e-mail address identifying the communication partner terminal 101 comprised in the fingerprint-added data as a registered address in the address book and stores the transmitter's fingerprint data (task S51). The fingerprint data is added to the fingerprint-added data as the transmitting terminal owner's fingerprint data in the address book. As a result, for example, as shown on the last line of the table 1000 shown in FIG. 10, the registered address fa and fingerprint data fb are respectively stored as the registered address and transmitting terminal owner's fingerprint data in the address book without storing the name of the transmitting terminal owner. Then, task S28 is performed.

Then, if the mobile terminal 1 receives the fingerprint-added data transmitted by the same transmitter by operating the same communication partner terminal 101, the control module 19 goes through tasks S21, S23, and S25 to perform task S54. The control module 19 determines whether the name of the transmitting terminal owner corresponds to the registered address determined to correspond to the received address in the address book (inquiry task S54).

If the control module 19 determines that the name of the transmitting terminal owner does not correspond to the registered address determined to correspond to the received address (“NO” branch of inquiry task 54), the control module 19 provides notification on the notification module 14d of the touch panel 14 (that the transmitter in unknown and that the fingerprint data of the transmitter have already been stored (task S55). Therefore, task S22 is performed in the previous receiving operation, and then, as on the last line of the table shown in FIG. 10, if the fingerprint-added data transmitted by the same transmitter by operating the same communication partner terminal 101 are received without storing the name of the transmitting terminal owner, task S55 is performed. Process 900 may then lead to task S28 as described above in the context of discussion of the process 600.

If the control module 19 determines that the name of the transmitting terminal owner corresponds to the registered address determined to correspond to the received address (“YES” branch of inquiry task 54), task S27 is performed. Therefore, if the name of the transmitter terminal owner has been stored as shown on the last line of the table shown in FIG. 10 by excluding the item names, task S27 is performed.

Next, the process in task S52 will be described. After task S24, in task S52, the control module 19 stores the transmitter's fingerprint data added to the fingerprint-added data as the potential impersonator's fingerprint data in the address book. As a result, for example, as shown on the second line from the bottom of the table shown in FIG. 10, the potential impersonator's fingerprint data are stored as the fingerprint data ed in the address book. Then, task S28 is performed.

Then, if the mobile terminal 1 receives the received data transmitted by the same transmitter by operating the same communication partner terminal 101, the control module 19 goes through task S21, task S23, and performs task S24. In task S24, when the control module 19 determines that the potential impersonator's fingerprint data have already been stored, it provides notification on the notification module 14d of the touch panel 14 ( ) of the registered address and that there is a possibility of impersonation and that the transmitter's fingerprint data have already been stored. Therefore, when task S24 is performed in the previous receiving operation and the potential impersonator's fingerprint data have been stored as shown in the second line from the bottom of the table shown in FIG. 10, if the fingerprint-added data transmitted by the same transmitter by operating the same communication partner terminal 101 have been received, the notification is provided.

Next, the process of task S53 will be described. After task S26, in task S53, the control module 19 stores the transmitter's fingerprint data as impersonator's fingerprint data in the address book. As a result, for example, as shown on the top line of the table 1000 shown in FIG. 10 by excluding the item names, the impersonator's fingerprint data are stored as the fingerprint data dc in the address book. Then, task S28 is performed.

Then, if the mobile terminal 1 receives, the received data transmitted by the same transmitter by operating the same communication partner terminal 101, the control module 19 performs tasks S21, S23, S25 and S26. In task S26, when the control module 19 determines that the impersonator's fingerprint data have already been stored, it provides notification on the touch panel 14 (notification module 14d) that there is a possibility of impersonation and that the fingerprint data of the transmitter have already been stored. Therefore, when task S26 is performed in the previous receiving operation and the impersonator's fingerprint data is stored as shown on the top line of the table shown in FIG. 10 by excluding the item names, if the fingerprint-added data transmitted by the same transmitter by operating the same communication partner terminal 101 have been received, the notification is provided.

In an embodiment of the disclosure, the control module 19 also determines whether the operator of the mobile terminal 1 is a registered person in task S32 of process 800B as shown in FIG. 8B. Specifically, the control module 19 determines whether the operator's fingerprint data redetected on the biological information detection module 14c of the touch panel 14 correspond to the transmitter's fingerprint data or registered person's fingerprint data (task S31).

If the control module 19 determines that the operator's fingerprint data redetected by the touch panel 14 correspond to the transmitter's fingerprint data or registered person's fingerprint data (“YES” branch of the inquiry task S32), the control module 19 displays the fingerprint-added data on the display module 14a of the touch panel (task S33) and process 800B stops.

However, if the control module 19 determines that the operator's fingerprint data redetected by the touch panel 14 do not correspond to the transmitter's fingerprint data and do not correspond to the registered person's fingerprint data (“NO” branch of the inquiry task S32), process 800B determines that the received data cannot be browsed (task S34), and process 800B stops.

According to an embodiment, if the operator is determined not to be a registered person once but the operator is determined to be a registered person the next time, the fingerprint-added data are displayed on the mobile terminal 1. Therefore, for example, even if the registered person forgets to disable the fingerprint identification function of the mobile terminal 1 and asks someone near the registered person to operate the mobile terminal 1 and the fingerprint-added data are not displayed, the fingerprint-added data can be browsed if the registered person operates the mobile terminal 1 the next time.

If there is no need to determine impersonation, task S14 and task S32 described above may be performed together instead of separately.

FIG. 10 illustrates the contents of the address book stored in the storage device 11 in a table 1100. Impersonator's fingerprint data, which are fingerprint data of those impersonating a registered user, and potential impersonator's fingerprint data, which are fingerprint data of those who may is impersonating a registered user, is added to and stored in the address book.

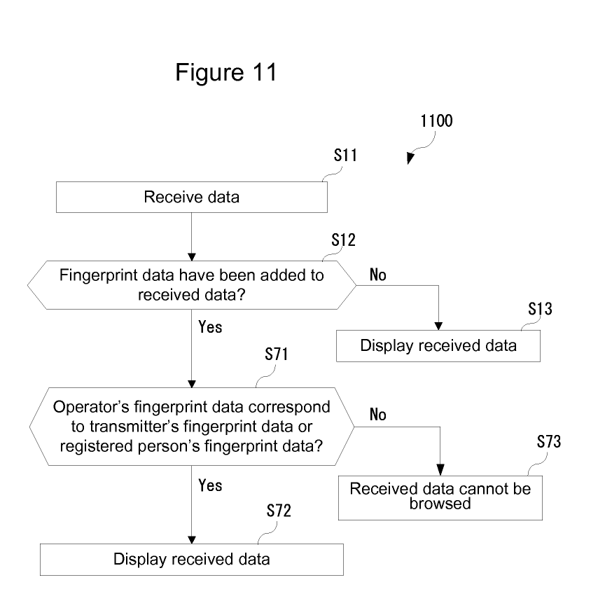

FIG. 11 is an illustration of a flowchart showing a receiving process 1100 of the mobile terminal 1 according to an embodiment of the present disclosure. The various tasks performed in connection with the process 1100 may be performed by software, hardware, firmware, a computer-readable medium having computer executable instructions for performing the process method, or any combination thereof. The process 1100 may be recorded in a computer-readable medium such as a semiconductor memory, a magnetic disk, an optical disk, and the like, and can be accessed and executed, for example, by a computer CPU such as the control module 19 in which the computer-readable medium is stored. It should be appreciated that process 1100 may include any number of additional or alternative tasks, the tasks shown in FIG. 11 need not be performed in the illustrated order, and process 1100 may be incorporated into a more comprehensive procedure or process having additional functionality not described in detail herein. For illustrative purposes, the following description of process 1100 may refer to elements mentioned above in connection with FIGS. 1-10. In practical embodiments, portions of process 1100 may be performed by different elements of the mobile terminal 1 for example the storage device 11, the sound receiving module 12, the sound generation module 13, the touch panel 14, the communication module 15, and the control module 19, etc. The process 1100 may have functions, material, and structures that are similar to the embodiments shown in FIGS. 1-10. Therefore common features, functions, and elements may not be redundantly described here.

In process 1100 task S14, process 600, and process 800 of the process 500 shown in FIG. 5 have been changed to task S71, task S72, and task S73. Therefore common features, functions, and elements may not be redundantly described here.

If the control module 19 determines that the received data received by the receiving module 15b are fingerprint-added data (inquiry task 12), the control module 19 detects the operator's fingerprint data on the biological information detection module 14c of the touch panel 14 at the time of acceptance of an input operation for displaying the received data on the operation module 14b of touch panel 14. Then, the control module 19 determines whether the operator's fingerprint data correspond to the transmitter's fingerprint data or registered person's fingerprint data (inquiry task 71).

If the control module 19 determines that the operator's fingerprint data correspond to the transmitter's fingerprint data or registered person's fingerprint data (“YES” branch of inquiry task S71), the control module 19 displays the fingerprint-added data to which the transmitter's fingerprint data have been added on the touch panel 14 (display module 14a) in task S72. Therefore, if the transmitter or registered person who has transmitted the fingerprint-added data operates the mobile terminal 1, the fingerprint-added data are displayed on the mobile terminal 1.

If the control module 19 determines that the operator's fingerprint data do not correspond to the transmitter's fingerprint data and the operator's fingerprint data do not correspond to the registered person's fingerprint data (“No” branch of inquiry task S71), task S73 is performed. In task S73, although the operation to display the fingerprint-added data to which the transmitter's fingerprint data have been added on the touch panel 14 has been performed on the touch panel 14, the control module 19 prohibits the fingerprint-added data from being displayed on the touch panel 14. Therefore, it is possible to prevent a third party other than the registered person or transmitter from browsing the fingerprint-added data of the mobile terminal 1 more securely.

After the control module 19 performs task S32 in process 800 as shown in FIG. 8, according to an embodiment of the disclosure, the control module 19 stores the e-mail address identifying the communication partner terminal 101 as the registered address in the address book and also stores the transmitter's fingerprint data in the address book. Thus, it is possible to omit input operations to store the e-mail address and the transmitter's fingerprint data in the address book.

When the control module 19 performs task S34 shown in process 800 in FIG. 8, a signal notifying that the fingerprint-added data are prohibited from being displayed is transmitted from the transmitting module 15a to the communication partner terminal 101 that has transmitted the fingerprint-added data. This allows the mobile terminal 1 to notify the transmitter that an operation to display the data transmitted by him/her has been performed but the data have been prohibited from being browsed on the transmission destination of the mobile terminal 1.

When the control module 19 performs the same task S34, the control module 19 disables subsequent input operations on the touch panel 14. This allows the mobile terminal 1 to prevent improper use by third parties. When the control module 19 performs the same task S34, it turns the backlight of the LCD of the touch panel 14 OFF. This allows the mobile terminal 1 to reduce power consumption.

After task S34, when the operator's fingerprint data are detected by the touch panel 14, the control module 19 determines whether the operator's fingerprint data correspond to the registered person's fingerprint data, and if it determines that they correspond, it releases the disabling of input operations on the touch panel 14 and turns the backlight of the LCD of the touch panel 140N. Then, the control module 19 displays that the mobile terminal 1 has been operated by a third party on the touch panel 14. Moreover, if it determines that there are received data that have never been displayed on the touch panel 14, it displays on the touch panel 14 that there are received data that have never been displayed. Herein, if the control module 19 determines that there are fingerprint-added data that have never been displayed on the touch panel 14, it may display on the touch panel 14 that there are fingerprint-added data that have never been displayed.

The mobile terminal 1 described above uses fingerprint data of the operator, etc. as information for accurately identifying the operator, etc. However, instead of fingerprint data, biological information other than fingerprint data, such as iris data identifying optical iris patterns or digital vein data identifying finger vein patterns, may be used. If the biological information detection module 14c comprises, for example, a camera that captures the operator's iris as image data, the biological information detection module 14c can detect iris data based on the image data. If the biological information detection module 14c comprises, for example, an infrared irradiation module that irradiates a plurality of infrared rays to a plurality of parts of the operator's finger and an infrared detection module that detects the plurality of infrared rays penetrated through the finger, the biological information detection module 14c can detect the operator's digital vein data based on the infrared rays detected by the infrared detection part.

In the above embodiments, if an input operation to transmit the data is performed in task S6 after the authorization level is read in tasks S3 and S4, the control module 19 detects the operator's fingerprint data on the touch panel 14 in task S7, adds the operator's fingerprint data to the data to be transmitted, and performs transmission to the communication partner terminal 101.

However, the above embodiments, are not limited to this, and after task S6 and before task S7, the control module 19 may display an indication on the touch panel 14 that prompts the operator to touch the touch panel 14. Moreover, in task S7, when the control module 19 displays as such, it may detect the operator's fingerprint data on the touch panel 14, add the detected operator's fingerprint data to the data to be transmitted, and perform transmission to the communication partner terminal 101. Alternatively, after task S6, in task S7, the control module 19 may add the registered person's fingerprint data stored in the storage device 11 to the data to be transmitted and perform transmission to the communication partner terminal 101 without detecting the operator's fingerprint data on the touch panel 14.

In the above embodiments, the mobile terminal 1 sets the authorization level and transmitting the set authorization level by including the authorization level in the data to be transmitted. However, the effect described above can be acquired even if the set authorization level is not necessarily transmitted by being included in the data to be transmitted, and the mobile terminal 1 may not have a function to set the authorization level. In this case, the details of the foregoing embodiments may be combined.

In an embodiment, if the mobile terminal 1 sets the authorization level, the mobile terminal 1 can select whether to transmit the authorization level through an input operation on the touch panel 14. In this case, regardless of whether the mobile terminal 1 transmits the authorization level, the details of the foregoing embodiments may be combined.

While at least one exemplary embodiment has been presented in the foregoing detailed description, the present disclosure is not limited to the above-described embodiment or embodiments. Variations may be apparent to those skilled in the art. In carrying out the present disclosure, various modifications, combinations, sub-combinations and alterations may occur in regard to the elements of the above-described embodiment insofar as they are within the technical scope of the present disclosure or the equivalents thereof. The exemplary embodiment or exemplary embodiments are examples, and are not intended to limit the scope, applicability, or configuration of the disclosure in any way. Rather, the foregoing detailed description will provide those skilled in the art with a template for implementing the exemplary embodiment or exemplary embodiments. It should be understood that various changes can be made in the function and arrangement of elements without departing from the scope of the disclosure as set forth in the appended claims and the legal equivalents thereof. Furthermore, although embodiments of the present disclosure have been described with reference to the accompanying drawings, it is to be noted that changes and modifications may be apparent to those skilled in the art. Such changes and modifications are to be understood as being comprised within the scope of the present disclosure as defined by the claims.

Terms and phrases used in this document, and variations hereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. A communication device comprising:
an operation module operable to accept an input operation performed by an operator;
a biological information detection module operable to detect first biological information of the operator;
a receiving module operable to receive received data comprising second biological information of a transmitter;
a display module operable to display the received data if not prohibited; and
a control module operable to prohibit the display module from displaying the received data, if the first biological information does not correspond to the second biological information and the first biological information does not correspond to third biological information of a registered person.

2. The communication device according to claim 1, wherein the control module is further operable to:
cause the biological information detection module redetect the first biological information to obtain redetected first biological information, if the first biological information does not correspond to the third biological information;
cause the display module to display the received data, if the redetected first biological information corresponds to the second biological information; and
prohibit the display module from displaying the received data, if the redetected first biological information does not correspond to the second biological information.

3. The communication device according to claim 2, wherein the control module is further operable to:
cause the display module to display the received data, if the redetected first biological information corresponds to the third biological information; and
prohibit the display module from displaying the received data, if the redetected first biological information does not correspond to the second biological information and the third biological information.

4. The communication device according to claim 1, further comprising:
a storage module operable to store fourth biological information of a transmitting terminal owner, wherein
the control module is further operable to determine whether the second biological information corresponds to the fourth biological information to obtain a determination result and notify the communication device of the determination result, if the first biological information corresponds to the third biological information.

5. The communication device according to claim 1, further comprising a touch panel coupled to the display module, the operation module, and the biological information detection module, wherein the biological information is fingerprint data.

6. The communication device according to claim 1, wherein the control module is further operable to store an authorization level.

7. A method for operating an electronic device, the method comprising:
detecting first biological information of a first operator performing an input operation to the electronic device;
receiving second biological information from a second operator of a second electronic device;
providing third biological information of a registered person; and
not displaying the received data, if the first biological information does not correspond to the second biological information and the first biological information does not correspond to the third biological information.

8. The method according to claim 7, further comprising:
redetecting the first biological information to obtain redetected first biological information, if the first biological information does not correspond to the third biological information;
displaying the received data, if the redetected first biological information corresponds to the second biological information; and
not displaying the received data, if the redetected first biological information does not correspond to the second biological information.

9. The method according to claim 8, further comprising:
displaying the received data, if the redetected first biological information corresponds to the third biological information; and
not displaying the received data, if the redetected first biological information does not correspond to the second biological information and the third biological information.

10. The method according to claim 7, further comprising:
storing fourth biological information of a transmitting terminal owner;
determining whether the second biological information corresponds to the fourth biological information to obtain a determination result, if the first biological information corresponds to the third biological information; and
notifying the electronic device of the determination result, if the first biological information corresponds to the third biological information.

11. The method according to claim 7, wherein the first biological information, the second biological information, and the third biological information comprise fingerprint data.

12. The method according to claim 7, wherein the first biological information, the second biological information, and the third biological information comprise iris data.

13. The method according to claim 7, further comprising storing an authorization level.

14. A computer readable medium comprising program code for operating a electronic device, the program code comprising:
detecting first biological information of a first operator performing an input operation to a first electronic device;
receiving second biological information from a second operator of a second electronic device;
providing third biological information of a registered person permitted to use the first electronic device; and
prohibiting displaying received data if the first biological information does not correspond to the second biological information and the first biological information does not correspond to the third biological information.

15. The computer readable medium according to claim 14, the program code further comprising code for:
redetecting the first biological information to obtain redetected first biological information, if the first biological information does not correspond to the third biological information;
displaying the received data, if the redetected first biological information corresponds to the second biological information; and
prohibiting displaying the received data, if the redetected first biological information does not correspond to the second biological information.

16. The computer readable medium according to claim 15, the program code further comprising code for:
displaying the received data, if the redetected first biological information corresponds to the third biological information; and
not displaying the received data, if the redetected first biological information does not correspond to the second biological information and the third biological information.

17. The computer readable medium according to claim 14, the program code further comprising code for:
storing fourth biological information of a transmitting terminal owner;
determining whether the second biological information corresponds to the fourth biological information to obtain a determination result, if the first biological information corresponds to the third biological information; and
notifying the electronic device of the determination result, if the first biological information corresponds to the third biological information.

18. The computer readable medium according to claim 17, wherein the first biological information, the second biological information, the third biological information, and the fourth biological information comprise fingerprint data.

19. The computer readable medium according to claim 14, wherein the first biological information, the second biological information, the third biological information, and the fourth biological information comprise iris data.

20. The computer readable medium according to claim 14, the program code further comprising code for storing an authorization level.
